(19) United States
(12) Patent Application Publication
(10) Pub. No.: US 2005/0029952 A1
(43) Pub. Date: Feb. 10, 2005

(54) Drive system

(75) Inventors: Harald Schweigert, Wien (AT); Harald Weinmeier, Wien (AT); Norbert Kaiser, Nurnberg (DE)

Correspondence Address: MONTE & MCGRAW, PC, 4092 SKIPPACK PIKE, P.O. BOX 650, SKIPPACK, PA, 19474, US

(73) Assignee: Siemens AG Osterreich, Vienna (AT)

(21) Appl. No.: 10/922,611

(22) Filed: Aug. 20, 2004

(30) Foreign Application Priority Data
Feb. 22, 2002 (AT) A 275/2002
Feb. 10, 2003 (WO) PCT/AT03/00036

(51) Int. Cl. H01J 23/34

(52) U.S. Cl. 315/1

(57) ABSTRACT

The invention relates to a drive system with at least one main motor (HMO) and at least one actuator motor (SM1, SM2). Said drive system comprises a.d.c. intermediate circuit (ZWK), in which the main motor, during deceleration in the generator mode, feeds the intermediate circuit, a control unit (STE) for monitoring and controlling the operation and for initiating and carrying out an emergency operation in case of a power failure, and a control power supply (SBN). An emergency power supply (NNT) for generating an emergency supply voltage (U_{B}) is connected to the intermediate circuit (ZWK). The level of said emergency supply voltage is lower than that of the rated operational voltage (U_{B}) of the control unit (STE). The outputs of the control power supply (SBN) and of the emergency power supply are applied together to the supply voltage input of the control unit. An output voltage control of the emergency power supply is adjusted to the emergency supply voltage (U_{B}′).

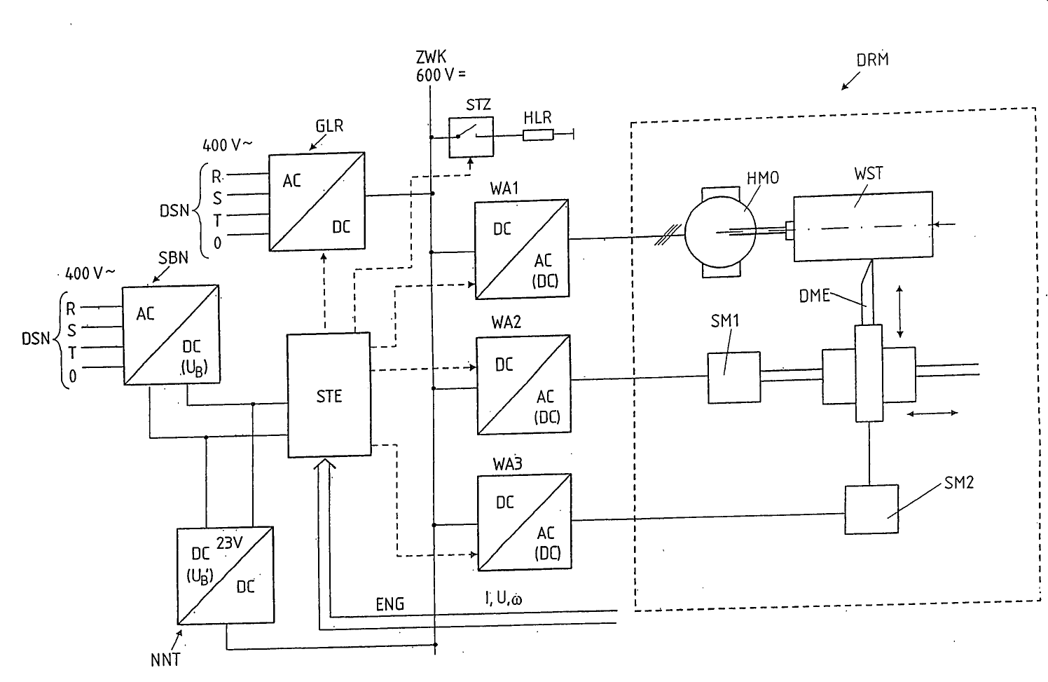

The invention relates to a drive system comprising:
at least one main motor and at least one actuator motor,
a d.c. intermediate circuit that connects to an a.c. system via a mains rectifier, it being possible for the intermediate circuit to supply power to the at least one actuator motor and the at least one main motor during motor operation,
a control unit for monitoring and controlling the operation of the system and for initiating and carrying out an emergency operation in the event of a power failure, and
a control power supply for generating a normal d.c. voltage for the control unit from an a.c. mains voltage, the control unit obtaining its operating voltage during emergency operation from the intermediate circuit via an additional power supply.

In drive systems of the representative type, at least one main motor moves relatively large masses, or the main motor itself possesses a high moment of inertia. An example of systems of this type is lathes on which a main motor turns a workpiece and actuator motors provide for a movement of a cutting tool. Other examples are power looms, conveyors, elevators, mill trains, etc.

The initial problem of such systems for the invention is with the operations that follow an unforeseen power failure. If no special measures are applied, the main motor runs on longer in the event of a power failure than the actuator motor, so that it is no longer possible, for example, to pull a cutting tool from the workpiece, which causes destruction. In a similar manner, with power looms there may be a thread break or safety problems in a very general sense may occur. To shut down the system safely, it is therefore necessary on the one hand to maintain the supply voltages for the actuator motors for a sufficient time and on the other hand to guarantee the presence of the normal d.c. voltage for the control unit long enough for the emergency operation to be terminated in an orderly manner, for example, for the actuator motors to have completed their run.

To shut down the system, an emergency program managed by the control unit is provided that, in the event of a power failure, enables an orderly shutdown procedure that usually leads to a defined, harmless original state for a restart. Depending on the system and program, periods ranging from several seconds to about a minute must be spanned, and power must be provided during this period in spite of the mains failure.

In known systems, upon detection of the power failure, the main motor is braked by generator operation and the energy produced is fed into a d.c. intermediate circuit, which is provided during normal operation from the a.c. system via a power rectifier. The actuator motors can then draw their power from this circuit during emergency operation. If necessary, braking resistors can be connected to the system for an accordingly quick braking.

The control unit is typically supplied from a control power supply that is also connected to the a.c. system. In order not to endanger the operation of the control unit in the event of a power failure, 24-volt rechargeable batteries are provided for the backup power supply; however, this solution is disadvantageous because of the limited service life of the rechargeable batteries. Moreover, there is a great effort involved in switching back off the rechargeable batteries after backup operation, in such a manner as to thereby prevent their partial discharge or destruction.

From German Patent 198 21 251 A1 a drive system of the type mentioned at the outset has become known with which, in the event of a disturbance—that is, if there is a power failure of the three-phase mains—the control unit is supplied by a d.c./d.c. transformer whose input is applied to the intermediate circuit and whose output is applied to separate input of the control unit. Details concerning the power supply of the control unit, especially regarding the switching between the voltage supplies cannot be derived from the document.

In a similar manner, the provision of a control voltage power supply from the intermediate circuit in the event of a mains voltage failure or interruption is known from German Patent 36 33 627 A1, a “coupling unit” being used for this purpose. Additional statements regarding the control voltage power supply or the coupling unit are not included in the document.

One object of the invention is to devise a drive system with which an absolutely safe emergency operation, in the sense of conducting an emergency program for shutting down the system, is ensured by the simplest possible means.

This objective is achieved by a drive system of the type mentioned at the outset in which, according to the invention, an emergency power supply for generating an emergency operating voltage is connected to the intermediate circuit, the level of the emergency operating voltage being under that of the rated operating current of the control unit, the outputs of the control power supply and the emergency power supply being applied together to the supply voltage input of the control unit and an output voltage control of the emergency power supply being adjusted to the emergency operating voltage.

Thanks to the invention, in normal operation a safe startup of the system is also possible, whereby, otherwise, in the event of a power failure, there is an automatic switching to the emergency power supply of the control unit that is supplied power by the intermediate circuit.

Regarding an especially economical design, it is advantageous if the emergency power supply is thermally dimensioned for short-term operation. In this sense, an additional improvement is possible if the emergency power supply is thermally dimensioned for a short operating time, the duration of which merely exceeds the period of the cycle for the emergency operation.

If at least one overtemperature sensor is provided in the emergency power supply to shut it down, there is an additional protection of the emergency power supply, which is set with low dimensions for continuous output.

An additional advisable version provides that the emergency power supply has an additional input voltage range. This is favorable because the intermediate circuit voltage can be dropped far down, especially when decelerating the system.

The invention, together with additional advantages, is explained in greater detail below in relation to an exemplary embodiment that is shown in the drawing. The single figure shows a drive system according to the invention in a sharply simplified illustration.

In the drawing, a drive system is illustrated as an exemplary embodiment of the invention that includes a lathe DRM as a mechanical core piece. Lathe DRM has a main drive motor HMO that via a gear set can generally displace a workpiece WST in rotation that is to be machined. In order to be able to execute, on the one hand, a movement of cutting tool DME in alignment with lathe DRM and, on the other hand, a feed motion, a first actuator motor SM1 and a second actuator motor SM2, typically servomotors, are provided.

Voltage is supplied to the motors from the a.c. or three-phase system DSN in the manner described below. A rectifier GLR produces—in this case from three-phase current—an intermediate circuit d.c. voltage of, say, 600 volts for an intermediate circuit ZWK. Alternatively, a boost chopper could be connected on the load side to a rectifier, or a controlled thyristor rectifier—possibly with an energy recovery function—could be provided in place of the rectifier. From the d.c. voltage of intermediate circuit ZWK, a transformer WA1 produces, for example, a 3-phase a.c. voltage for main motor HMO, if it is a three-phase current machine, or a corresponding d.c. voltage, if main motor HMO is a d.c. voltage machine.

In a similar manner, actuator motors SM1, SM2 are supplied from the intermediate circuit ZWK via transformers WA2, WA3, which can be either a d.c./d.c. or d.c./a.c. transformer.

The system is monitored and controlled using a control unit STE. This controller STE, which, for example, can contain one or more microprocessors, receives information about the current actual state of the system, e.g. about currents, voltages, speeds, spatial coordinates, temperatures, etc via input means ENG, such as interfaces, lines, keys, etc. Suitable programs control via, for example, transformers WA1, WA2 and WA3, the operation of the system, for example, a production sequence as well as the execution of an emergency operation in the sense of shutting down the system during a mains failure.

In normal operation, control unit STE is supplied with voltage by a control power supply SBN, this power supply DSN, e.g., 3×400 or 1×230 volts, generating a regulated or stabilized 24-volt output voltage U_{B}.

However, another emergency power supply NNT is also provided for the control unit that is formed as a d.c./d.c. converter and with its input applies a voltage to intermediate circuit ZWK, in this case a d.c. voltage of 600 volts. The output of emergency power supply NNT is also adjusted, but to an emergency operation voltage U_{B}′ that is set—and this is significant—below the rated voltage U_{B} of controller STE to, for example, 23 volts.

In normal operation, the intermediate circuit is supplied by rectifier GLR from mains DSN. In the event of a mains failure and initiation of emergency operation, the main motor HMO, which continues to run in generator braking mode because of its mass, supplies power to intermediate circuit ZWK, transformer WA1 then working in the opposing direction. In this context a braking resistor HLR comprising, for example, a plurality of high-load resistors, can break in on intermediate circuit ZWK via a protection STZ driven by controller STE in order to ensure a sufficiently quick braking of main motor HMO. Of course, a plurality of motors of the system can feed energy into intermediate circuit ZWK as generator power during braking operation.

As long as the intermediate circuit voltage is high enough, emergency power supply NNT supplies the operating voltage needed by control unit STE, then as an emergency voltage U_{B} of 23 volts, and emergency operation—the shutdown of the system—which lasts for example 30 seconds, can be carried out without a problem.

Because the emergency operation lasts only a short time, emergency power supply NNT may be thermally dimensioned for short-term operation, the operating time only having to exceed the duration of emergency operation. Therefore, emergency power supply NNT may be designed very economically; e.g., the costs for cooling elements or winding material are clearly reduced.

Another advantage of the invention is the fact that emergency power supply NNT may be constructed more easily for an additional input voltage range. Because of the brief operating times required for emergency power supply NNT, its degree of efficiency is without great significance, so that concepts can be applied that, although having a greater power loss, have a broad input voltage range for this purpose. Especially at low voltages, such a broad input voltage range is important, because during deceleration of the system the intermediate circuit voltage can drop down very far. Therefore, in this context an isolating transformer may also be used, which is not so suitable in continuous operation, because—in continuous operation—the transformer, the secondary rectification and the ripple current loading of the secondary electrolytic capacitors can cause thermal problems.

Since emergency power supply NNT is adjusted to an emergency supply voltage Us′<Us, it is ensured that in normal operation practically no power loss occurs in emergency power supply NNT. The voltage regulator of emergency power supply NNT, which is formed as a d.c./d.c. transformer, will adjust the power transmission upward only if control power supply SBN can no longer hold its output voltage U_{B}, i.e., drops below 23 volts in the aforementioned example.

The use of at least one overtemperature sensor in emergency power supply NNT, e.g. on a critical component such as a power semiconductor, prevents its destruction in the event of an outage or unintentional shutoff of the control power supply.

Emergency power supply NNT also requires only a few interference-suppression measures since it goes into operation for only a brief time, and that only very infrequently. This yields additional cost savings.

The fact that the controller is supplied with power, from mains DSN—in normal operation—and also from intermediate circuit ZWK—in emergency operation, ensures, along with the desired emergency operation, also the certainty that when the system switches on, that rectifier GLR, for example, may be switched to the mains via a protection (not shown) controlled by controller STE.

1. A drive system comprising:
at least one main motor (HMO)and at least one actuator motor (SM1, SM2),
a d.c. intermediate circuit (ZWK) that connects to an a.c. system (DSN) via a mains rectifier (GLR), it being possible for the intermediate circuit to supply power to the at least one actuator motor and the at least one main motor during motor operation,
a control unit (STE) for monitoring and controlling the operation of the system and for initiating and carrying out an emergency operation in the event of a power failure, and
a control power supply (SBN) for generating a normal d.c. voltage (U_{B}) for the control unit from an a.c. mains voltage, the control unit obtaining its operating voltage from the intermediate circuit via an additional power supply,
wherein
an emergency power supply (NNT) for generating an emergency supply voltage (U_{B}′) is connected to the intermediate circuit (ZWK), the level of the emergency supply voltage being lower than that of the rated operational voltage (U_{B}) of the control unit (STE), the outputs of the control power supply (SBN) and of the emergency power supply being applied together to the supply voltage input of the control unit, and an output voltage regulator of the emergency power supply being adjusted to the emergency supply voltage (U_{B}′).

2. The drive system as described in claim 1, wherein the emergency power supply (NNT) is thermally dimensioned for short-term operation.

3. The drive system as described in claim 2, wherein the emergency power supply (NNT) is thermally dimensioned for a short operating time whose duration merely exceeds the run time of the emergency operation.

4. The drive system as described in claim 1, wherein at least one overtemperature sensor is provided in the emergency power supply (NNT) to shut it off.

5. The drive system as described in claim 1, wherein the emergency power supply (NNT) has another input voltage range.
